(19) United States
(12) Patent Application Publication
(10) Pub. No.: US 2014/0288991 A1
(43) Pub. Date: Sep. 25, 2014

(54) PROJECT ESTIMATION AND PLANNING USING FEATURE GRANULARITY

(71) Applicant: Provably Correct LLC, New York, NY (US)

(72) Inventors: Craeg Kristian Strong, New York, NY (US); Martin A. Leroy, New York, NY (US)

(21) Appl. No.: 14/217,310

(22) Filed: Mar. 17, 2014

Related U.S. Application Data
(60) Provisional application No. 61/801,286, filed on Mar. 15, 2013.

(51) Int. Cl. G06Q 10/06

(52) U.S. Cl. CPC G06Q 10/06313
USPC 705/7.23

(57) ABSTRACT

A computer implemented method of generating a feature planning granularity metric in which the method includes receiving certain project estimation constraint metrics, obtaining a reference class of project data of historical reference projects, applying the project estimation constraint metrics in a reference class forecasting, and providing a metric representing the estimated cumulative identified features relative to the effort of the scope of the proposed project, for use in project planning as a feature planning granularity characteristic.

### CROSS-REFERENCE TO RELATED APPLICATION

This application claims the benefit of U.S. Provisional Application No. 61/801,286 filed on Mar. 15, 2013 and titled “Project Management System and Method Using Logistic Model Machine Learning Analytics.”

### BACKGROUND

Organizations pursuing projects that require substantial resources in the form of personnel, finances, hardware, and/or commitment of time have for a number of years been suffering from a deficiency in planning resulting in project failure. Such failure often causes substantial impact on the organization, resulting in unexpected setbacks in schedule, cost, quality and other factors of the undertaking, including potential effects on other projects and endeavors within the organization.

Several project management methodologies and tools have attempted to solve the problem of deficient planning Existing tools have used reference class forecasting techniques to assist in project planning by providing predicted outcomes for proposed project scenarios represented by characteristics of the project. Attempts have been made to improve reference class forecasting to provide better predictions of project performance based on similarity of character between the project to be estimated and projects included in the reference class that is used for the estimation. Such attempts have typically focused on narrowing the reference class of projects to those conducted within the same organization, and when possible to similar project teams, specific technical nature of the subject matter, and similar scope, duration, cost, and complexity.

Project management tools often include a feature completion progress schedule (an “FCPS”) that reports earned value delivery, showing running cumulative value of completed features during project execution, contributing to the planned effort of the scope of the project. An FCPS, commonly referred to as a burn-up or burn-down chart, reports completion of individual features in accordance with rules for determining the status of individual feature completion. In its graphical form, the FCPS shows completed features with respective relative size of each feature. The size is indicative of the amount of effort assigned to the feature during planning and scheduling, rather than the effort that is actually used to accomplish the work represented by the feature.

In the context of a work breakdown schedule or a similar work breakout or work breakdown structure, features designated for inclusion on an FCPS are those shown as terminal elements. For purposes of this specification, we refer to features designated for inclusion in an FCPS, and correspondingly designated to be a contributing feature to the planned scope of the project, as registered features. While elements of work from which terminal features were broken-down are commonly referred to as stories, themes, epics, and the like, for purposes of this specification, we refer to those elements, together with the registered features, all as identified features.

In the context of an FCPS, features of different sizes are indicative of different amounts of planned effort for the respective features. Registered features are actually revealed, or reported, on the FCPS upon completion of the planned work of the feature. On an FCPS, it is the planned effort of the feature that is reported, not the effort that was actually required to complete the work during the execution of the project. Actual effort is often shown in graphical depictions of running cumulative actual costs. Thus, the cumulative amount of effort of the planned features is the effort that contributes to measurement of progress of a project towards the criteria for completion—the planned scope of the project.

An FCPS in graphical form typically takes on a sigmoidal shape, or what may commonly be referred to as an S-curve shape. In the project planning context, certain logistic models have been used in reference class forecasting to predict the FCPS.

Despite all of these efforts and these tools, organizations nevertheless continue to have less than desirable results for their projects. Consequently, large magnitudes of value continue to be lost, especially in the case of larger projects. As such, there is a need for easy to use, more effective guidance to produce better project performance in accordance with more accurate project estimates and associated monitoring and control.

### SUMMARY

While it is known that insufficient planning, or excessively detailed upfront planning, has contributed to failure of projects to be completed on-time, on-budget, and to the satisfaction of the customer, we recognized that there has not been an effective way for project personnel to determine the appropriate amount of planning at the appropriate level of feature sizes, or at what times of the project such amounts of planning should occur, all in order to yield higher rates of project performance success. In accordance with the invention we disclose a system and method that uses a feature planning granularity metric to characterize a project. The feature planning granularity metric can be expressed in any of a variety forms, to represent the number of identified features of a project relative to the planned effort of the scope of the project. The feature planning granularity metric can be indicative of a running cumulative number of identified features during the course of a project, and thus, when tied to the then-current planned scope of the project, may take the form of a feature identification progress schedule (an FIPS).

In an embodiment of the invention, the feature planning granularity characteristic is a project estimation response field for a proposed project scenario. In conjunction with reference class forecasting to determine likely project performance of a project having user chosen project estimation constraints indicative of a project scenario, the feature planning granularity metric is determined and presented for use in guidance on the amount of planning associated with the predicted performance of the project. This amount of planning is indicative of the amount of feature breakout effort of the identified features, and can be presented with reference to the amount of planning at one or more particular times during in the course of the project.

In another embodiment of the invention, the feature planning granularity characteristic is a project estimation constraint field for a proposed project scenario. In conjunction with reference class forecasting to determine likely project performance of a project having user chosen project estimation constraints indicative of a project scenario, the feature planning granularity metric is also presented as a project estimation constraint, and used as a factor in project estimation.

In another embodiment of the system and method, the scope of the proposed project and the respective scopes of the historical reference projects used in reference class forecasting, each use a baseline unit of measure that is full-time-equivalent-person-days (as defined below).

In another embodiment, feature identification progress can be viewed at individual levels of feature size, forming a profile by feature size of the progress of feature identification, all of which is represented in a feature planning granularity metric.

Any of the above-described functionality can be used for mid-course project estimation and control. Also, any combination of the functionality described and the embodiments described may be incorporated as an embodiment of the invention.

Other advantages and features of the system and method are evident from the remainder of the disclosure herein.

### BRIEF DESCRIPTION OF THE DRAWINGS

FIG. 1 is a diagram illustrating a project management S-curve according to various embodiments.

FIG. 2 is a schematic diagram illustrating a project management process environment according to various embodiments.

FIG. 3 is a diagram illustrating a project management and data services environment according to various embodiments.

FIG. 4 is a diagram illustrating an interactive screen display of the client interface depicting a project scenario, and feature planning granularity as a project estimation response field, according to various embodiments.

FIG. 5 is a diagram illustrating an interactive screen display of the client interface depicting another project scenario, and feature planning granularity as a project estimation constraint field, according to various embodiments.

FIG. 6 is a diagram illustrating an interactive screen display of the client interface depicting a mid-course project correction scenario, and feature planning granularity as a project estimation constraint field, according to various embodiments.

FIG. 7 is a schematic diagram illustrating selection of optional project estimation fields according to various embodiments.

FIG. 8 is a schematic diagram illustrating metrics and components of a feature planning granularity characteristic and a corresponding feature completion progress schedule according to various embodiments.

FIG. 9 is a flow diagram illustrating a process for project management in which the system may be applied.

FIG. 10 is a schematic diagram illustrating reference class response determination in accordance with various embodiments.

FIG. 11 is a schematic diagram illustrating creation and selection of a reference class curve determination technique according to various embodiments.

FIG. 12 is a schematic diagram illustrating components of computational curve fitting techniques according to various embodiments.

FIG. 13 is a block diagram illustrating components of an embodiment of the system.

### DETAILED DESCRIPTION

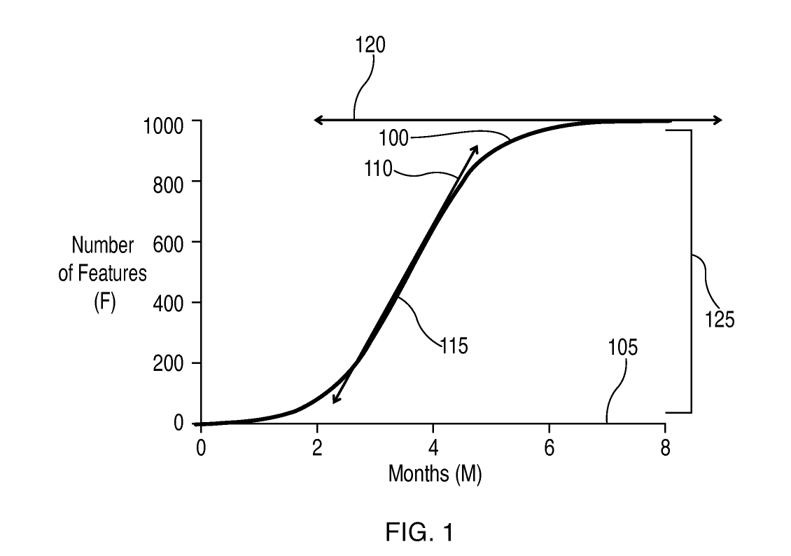

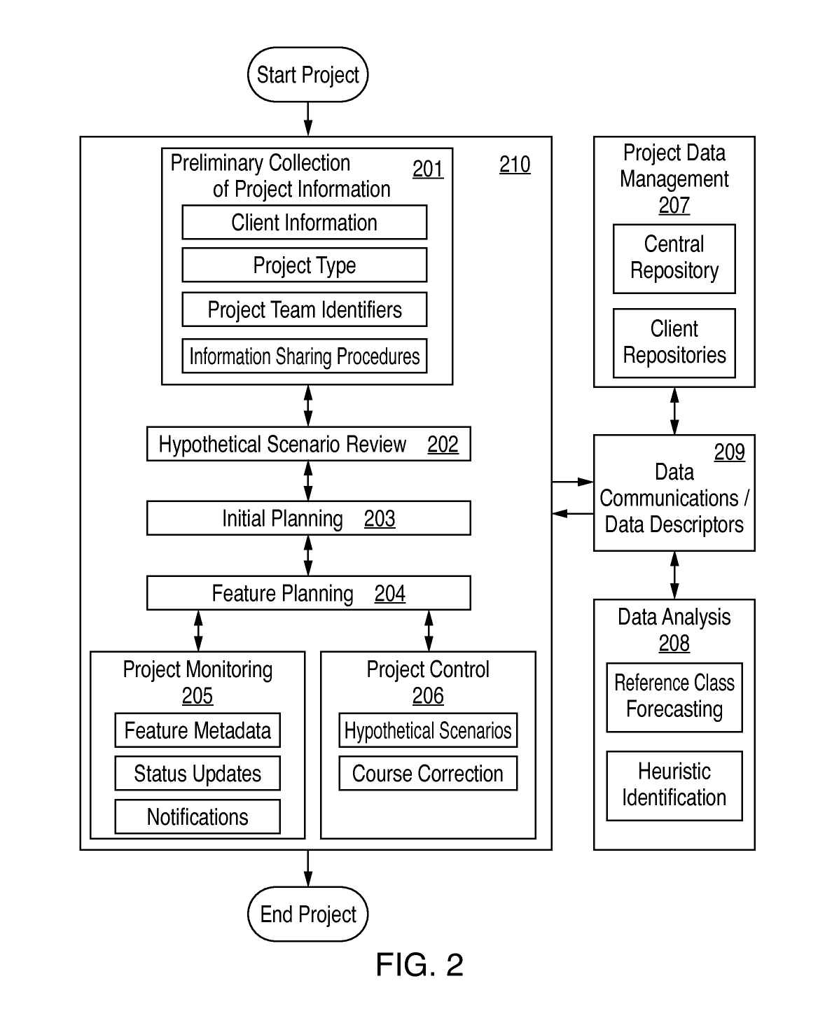

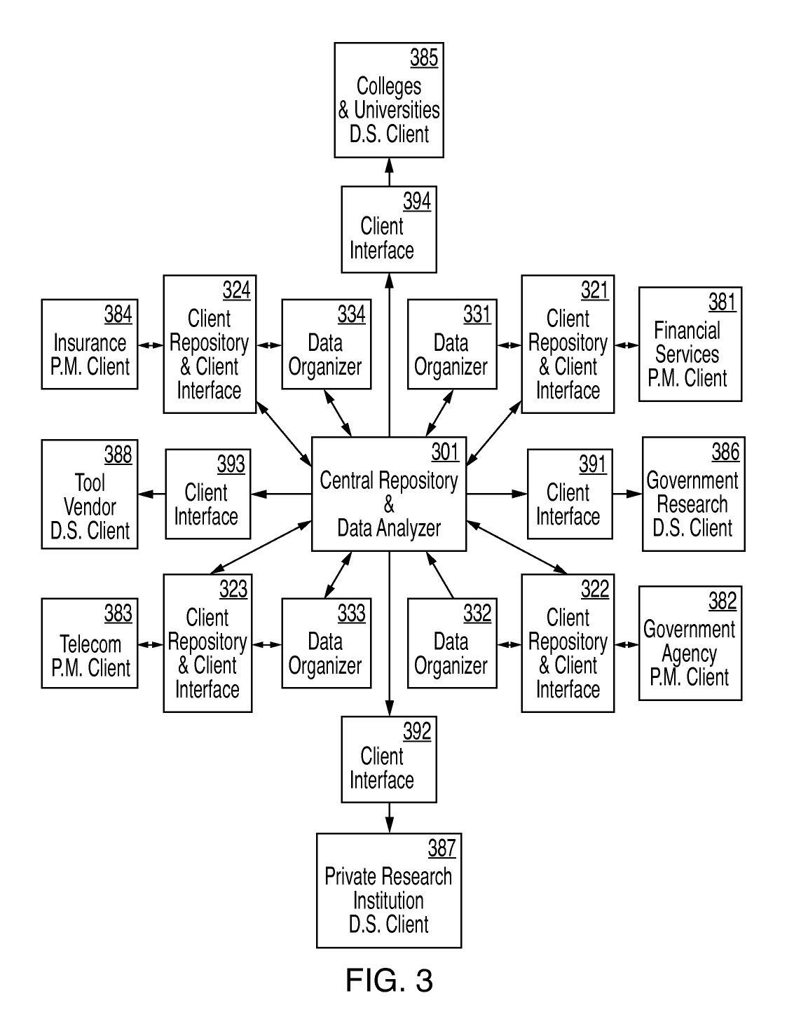

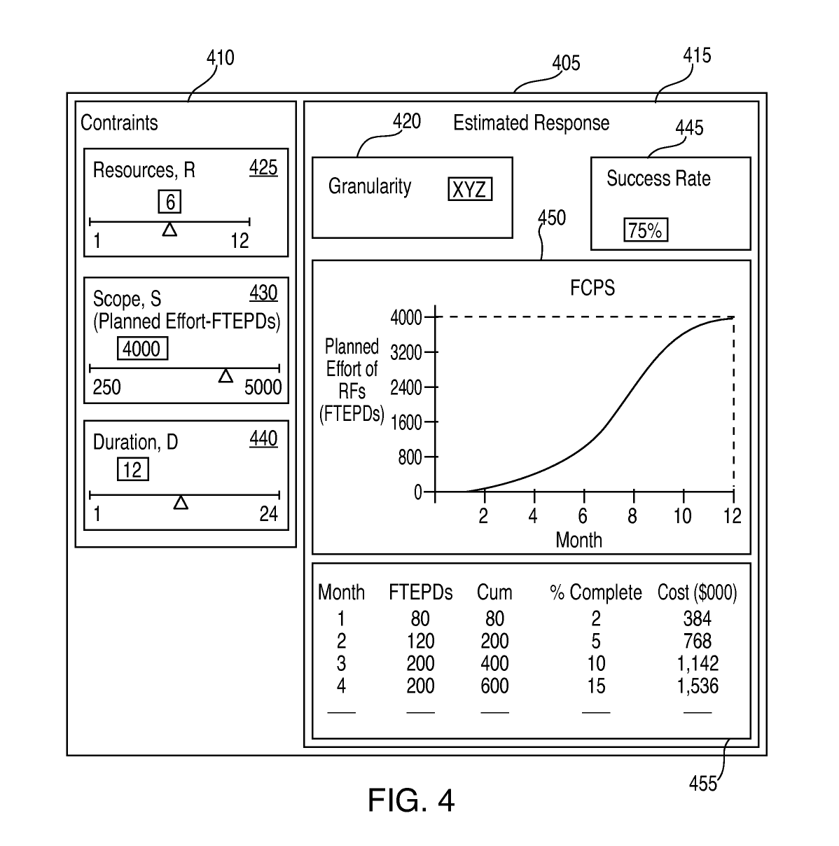

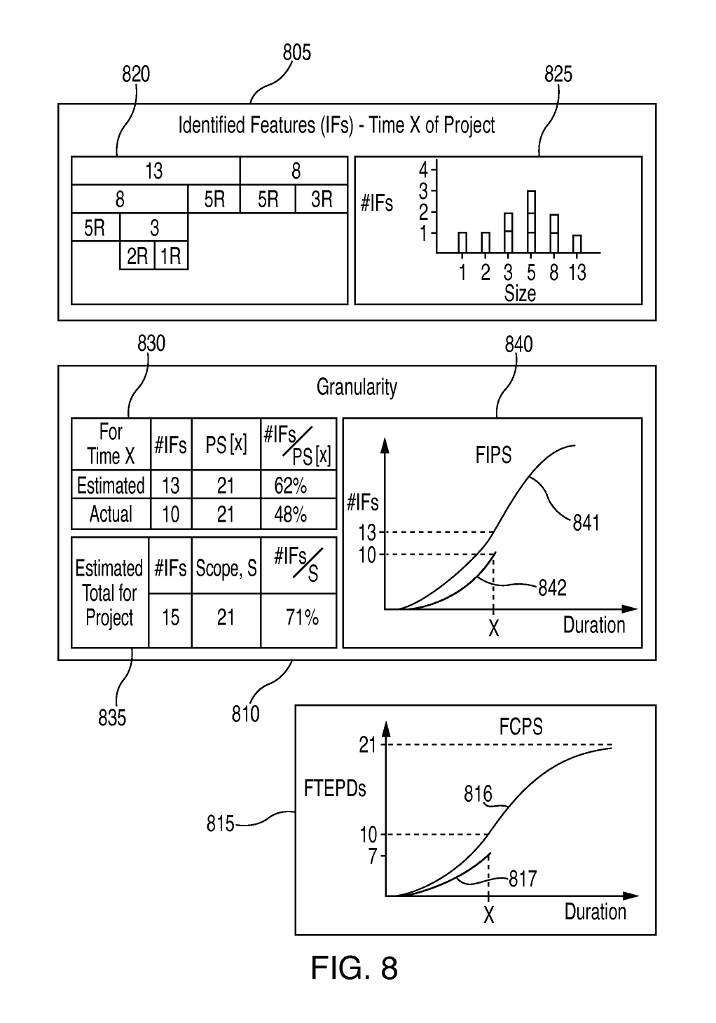

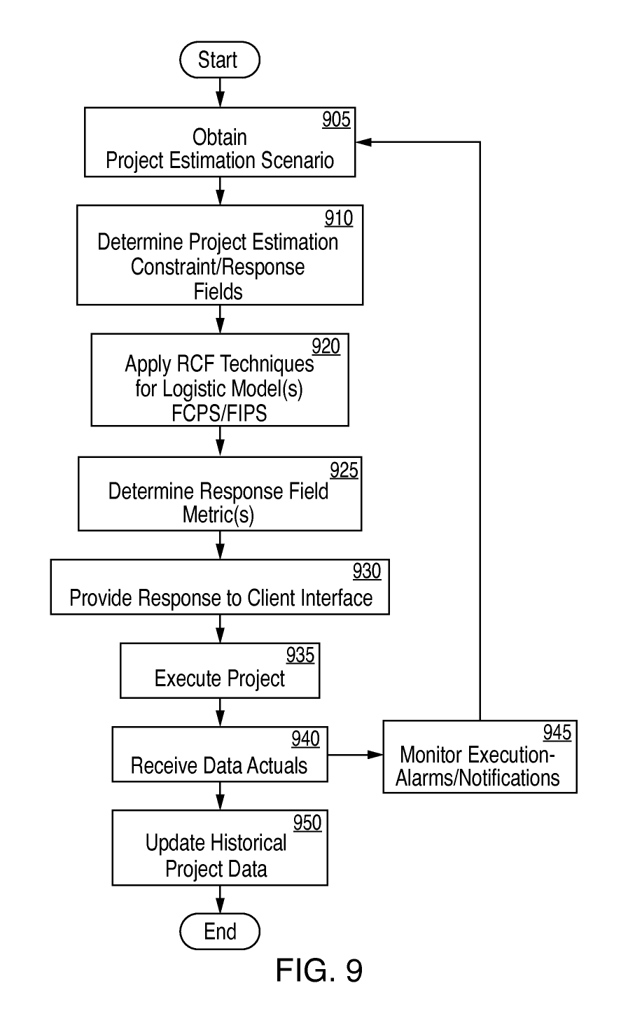

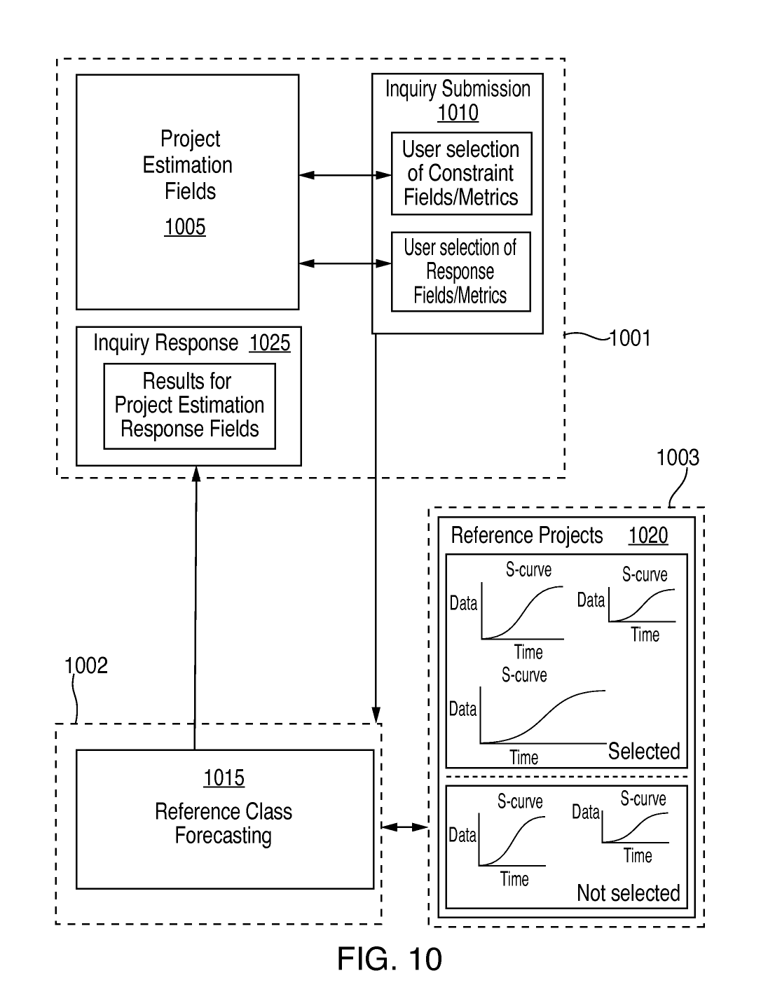

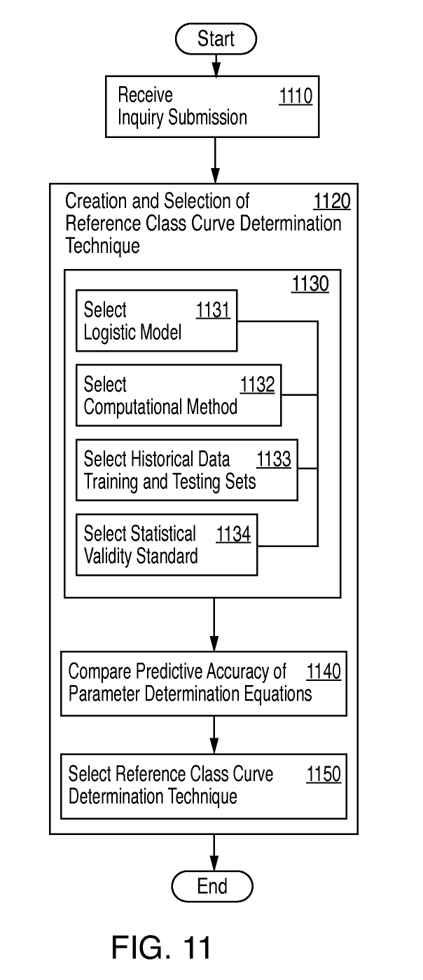

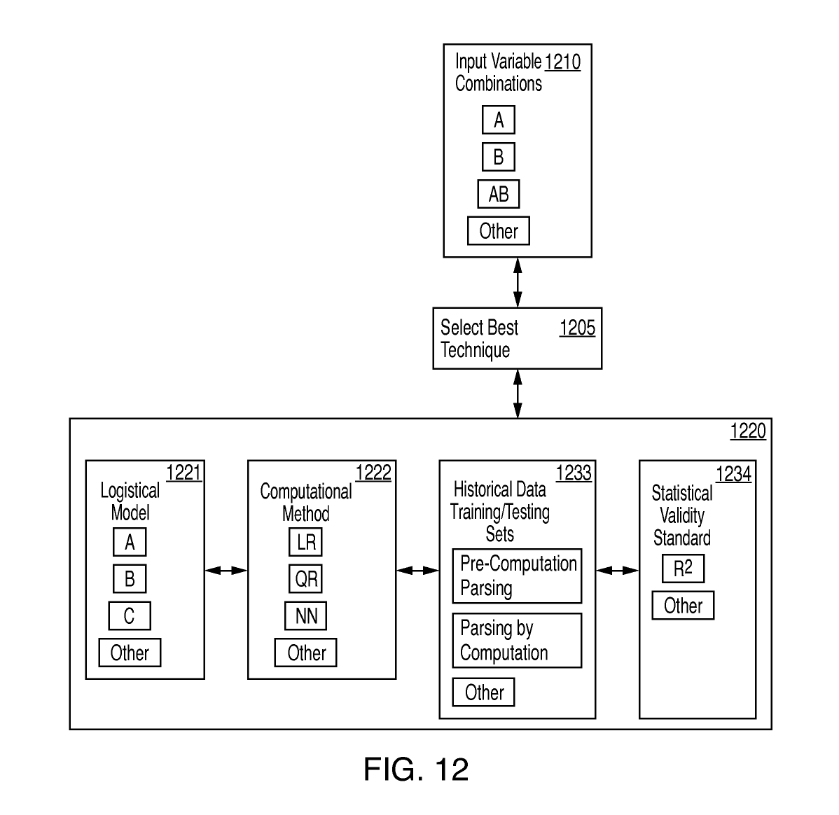

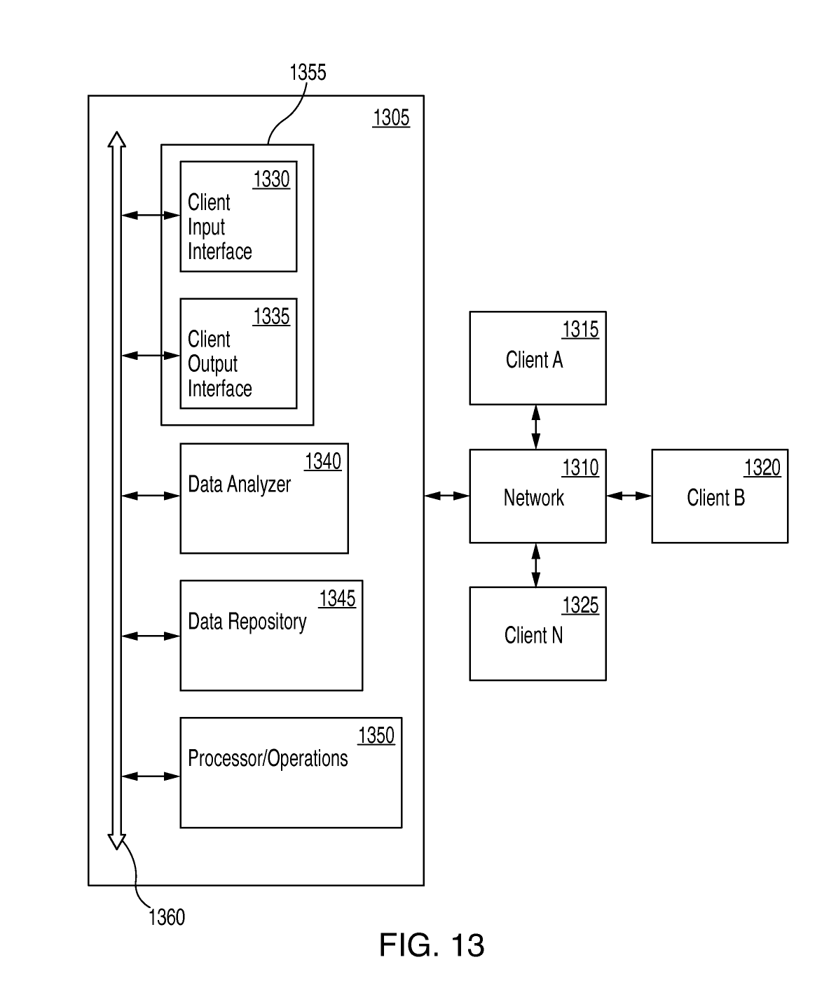

What follows immediately below, in connection with FIG. 1, is a general description of parameters of an exemplary logistic model that may be used in the reference class forecasting functionality of the system and method. Then, discussion in connection with FIG. 2 presents an exemplary project management process environment in which embodiments of the invention may be applied. Discussion in connection with FIG. 3 presents an overview of a project management and data services environment in which embodiments of the invention may be applied. Next, a discussion in connection with FIG. 13 presents system components and corresponding functionality, including functionality of reference class forecasting with project characteristics, and a baseline unit of measure of effort for individual feature size and project scope, as may be applied in various embodiments. An embedded discussion in connection with FIGS. 11 and 12 includes description of exemplary reference class curve determination techniques, and corresponding computational methods, as may be applied in the reference class forecasting functionality of the system and method. Then, in accordance with the invention, a discussion in connection with FIG. 9 presents a more detailed description of an exemplary process for project management, along with cross-references to the system components of FIG. 13, in which a feature planning granularity characteristic may be used as a project characteristic. Exemplary configurations of feature planning granularity metrics for the feature planning granularity characteristic are presented in a discussion in connection with FIG. 8. Then, discussions in connection with FIGS. 4, 5, 6, and 7 provide representative examples of project estimation fields, and the selection of project estimation constraint fields and project estimation response fields, incorporating the feature planning granularity characteristic. A discussion in connection with FIG. 10 includes a description of reference class response determination as may be applied in the system and method.

FIG. 1 is a diagram illustrating a project management S-curve according to various embodiments. As will be further detailed below, in accordance with the invention, logistic modeling of S-curves is used in reference class forecasting determination of metrics for project estimation fields. As shown in FIG. 1, an S-curve 100 has associated governing parameters in accordance with the following logistic equation:

F=d+(a−d)/1+(M/c)̂b)̂g (1)

The S-curve 100 can represent a typical feature completion progress schedule (FCPS) or a feature identification progress schedule (FIPS). Referring to the formula (1), the S-curve 100 has parameter “a” that governs a lower asymptote 105, which in this case, is also the horizontal axis of the graph. Parameter “d” governs an upper asymptote 120. Parameter “b” governs a slope 110. Parameter “c” governs placement of an inflection point 115, and parameter “g” is an asymmetry factor 125. The asymmetry factor 125 is associated with five-parameter logistic curves, and it models asymmetry that may exist between the ramp up and ramp down portions of S-curves such as the S-curve 100. Another example of a logistic model that may be used by the system and method in its reference class forecasting, is the five parameter 5PL-1PL equation:

a/(1+(d*10̂)((1b)*(log(2̂(1/c)−1)))/time)̂b)̂c

FIG. 2 is a schematic diagram that illustrates an exemplary project management process environment of the system and method. It is a high-level overview of the project management process in which the embodiments of the invention may be used. In FIG. 2, the project management process starts with a preliminary collection of project information 201, through a client interface 210. The preliminary collection of project information 201 includes machine requests for client identification information, project type, project team identifiers, and information sharing procedures or preferences. Information sharing procedures govern how client-related information will be used in the system, and may satisfy a client designated level of protection for proprietary, confidential or other information of a sensitive nature. For purposes of this disclosure, the terms client and user may be used interchangeably. For example, references to a client interface can also be user interface. Similarly, references to user activities can also be client activities. Also, third party computer systems can be clients and users, such as in the case of some embodiments in which inquiry submissions can be provided by third party project management services and systems.

The preliminary collection of project information 201 may be followed by a hypothetical scenario review 202, which in turn may be followed by an initial planning 203, which in turn may be followed by a feature planning 204. At this point, project execution will begin or will already have begun. As is shown in FIG. 2, the project management process is a fluid process and each of the preliminary collection of project information 201, hypothetical scenario review 202, initial planning 203 and feature planning 204 may be returned to at any time during the course of the project. As performance of scheduled features occurs, the project management process may continually carry out a project monitoring 205. The project monitoring 205 typically includes monitoring of feature status through observance of feature metadata. The project monitoring 205 also provides status updates and notifications to users. In conjunction with the project monitoring 205, a user may consider further hypothetical scenarios for purposes of altering the course of the project. If the user desires to adjust project characteristics, such as project scope, budget (cost), number of resources, type of resources, or duration, a project control 206 enables users to make those course corrections. All of these activities are supported by functionality of project data management 207, data communications 209, and data analysis 208. Upon determining a desired new project scenario, a user, through project control 206, can make a course correction by adjusting project characteristics such as scope, budget (cost), number of resources, type of resources, or duration.

During data analysis 208, the system processes user proposed project scenarios and provides a response through the client interface 210, such response being referred to as an inquiry response. Project data management 207 can use a central repository of data for storage of a wide variety of data, including data from past projects, projects currently in process, machine learning data generated by the system, and other systems operations data used in servicing clients. Certain project related data can also be stored in client repositories of data which can provide different levels of security for sensitive client information. Data analysis 208 includes application of reference class forecasting on historical project data collected by the system over time. Reference class forecasting is used to provide project estimation in response to client submitted project scenarios. Heuristics identification functionality can add a layer of machine learning functionality to predictive analytics and to library building activities associated with the central repository.

FIG. 3 is an illustration of a project management and data services environment in which the system and method may be applied. It shows a variety of clients that may use the system for project management services or data research services in a cloud-based network using a data organizational structure that protects client proprietary information. A central repository & data analyzer 301 stores project data, and may also store systems operations data and process algorithms. Representative project management services clients, shown as client 381, client 382, client 383, client 384, have their project management information stored and communicated by the system through respective client repository & client interface 321, client repository & client interface 322, client repository & client interface 323, and client repository & client interface 324, and have their data managed by respective data organizer 331, data organizer 332, data organizer 333, and data organizer 334. Data services clients, shown as client 385, client 386, client 387, and client 388, interact through respective client interface 394, client interface 391, client interface 392, and client interface 393. Each client's repository is independent of the other client repositories so that each client cannot access another client's repository.

Referring to FIG. 13, in accordance with the invention, a system 1305 receives a project scenario submitted by a user through a client input interface 1330 of a client interface 1355. The client interface 1355 also has a client output interface 1335 for providing a response to the user. A data repository 1345 stores project data of historical reference projects and feature completion data from the current project, if available. The data repository 1345 can store data directly in memory or otherwise act as an accessing mechanism to other storage locations of the data. In either case, it functions as a repository of historical data for purposes of use by a data analyzer 1340. Project data can include any of a variety of information, and comprises project characteristics such as project scope, project duration, project cost, and project resources, the feature completion progress schedule (FCPS), the feature identification progress schedule (FIPS), feature metadata such as feature identification date, feature work status, and feature completion date, and depending upon information sharing procedures, feature work descriptions. Each individual FCPS, and each individual FIPS, whether in graphical form or other form, and all of the other project characteristic data when expressed as values of the actuals, are the respective metrics indicative of characteristics of the historical reference projects.

In some embodiments of the invention, the data repository 1345 may store features having a baseline unit of measure of effort in the form of full-time-equivalent-person-days (or FTEPDs). When used in the context of project planning, FTEPDs is a generalized measure of effort that does not require any specific compensation or accounting for a person's time spent on distractions, scrum sessions, other in-office non-work related interactions and similar general office activities. The FTEPD is a unit that is a rough estimate made in project planning, based on general experience of those involved in planning. Many project team members work in shifts based on a single day and have an intuitive feel for how much work can be accomplished in the time frame of a day, even if a team member does not actually work on just one feature in a day. Such intuitive feel tends to be more accurate than an estimate for work that would require longer periods of times to accomplish. A daily routine, in which a system 1305 can provide prompts for at least one status check of feature progress, is another intuitive point of reference for team members in guiding formation of FTEPD based features. Those prompts, however, are not required as part of the system 1305. Descriptions anchored on the single FTEPD are also convenient for purposes of team members having a description to present in daily status update meetings, called scrum sessions, which will be understood by those of comparable skill in the profession.

To the extent that registered features of reference projects have the size of a single FTEPD, or approach the size of a single FTEPD as part of a statistically comparative large scope project, larger numbers of reference projects may serve as bases for reference class forecasting. Variances in project planners' estimations of how much work can be accomplished in a single FTEPD are statistically overtaken as more projects of larger scope are included and used as bases for reference class forecasting.

Referring back to FIG. 13, a data analyzer 1340 applies reference class forecasting on reference projects from the data repository 1345 using logistic modeling on the FCPS or FIPS data of the reference projects. Techniques of logistic modeling in reference class forecasting generally, are known. In some embodiments of the invention, the system and method may use heuristics and generally known techniques of back-testing, to determine what logistic model, computational method, training set selection and model testing method, and selection of validity standard for measuring predictive accuracy of curve fit and corresponding predictive model accuracy to use. Also, in some embodiments of the invention, an inquiry submission received by data analyzer 1340 may prompt a process for creating and selecting a reference class curve determination technique.

FIG. 11 is a schematic diagram illustrating creation and selection of a reference class curve determination technique that may be used for logistic modeling of FCPS and FIPS data in the system and method. A receipt of inquiry submission 1110 initiates a creation and selection of reference class curve determination technique 1120. Determining a logistical modeling technique may include modeling factor selection 1130, a comparison of predictive accuracy of test models 1140, and a selection of curve determination technique 1150. Modeling factor selection 1130 may include a selection of logistic model 1131, a selection of computational method 1132, a selection of historical data training and testing sets 1133, and a selection of statistical validity standard 1134, all for use in generating trial combinations of different test models for comparison, and then, selection of reference class curve determination technique 1150.

FIG. 12 is a schematic diagram further illustrating components of computational curve fitting techniques. A curve technique selector 1205 receives a variety of input variable combinations from an input variable creator 1210. Variable combinations can include, for example, scope ranges, duration ranges, cost ranges, and resource ranges of project characteristics. A modeling factor selection component 1220 includes modules for a logistic model selection 1221, a computational method selection 1222, an historical data set selection 1233, and a statistical validity standard selection 1234. Illustrative examples of computation methods including linear regression, quadratic regression, and nearest neighbor are depicted as options for the computational method selection 1222. Pre-computation parsing of historical projects, such as by choosing projects of only one type, for example federal governmental projects, is an option for the historical data set selection 1233. In another example, parsing by computation, such as by assigning quantitative values to qualitative factors for use in regression analyses, is an option for the historical data set selection 1233. A statistical validity standard such as R-squared, or t-testing, may be options for the statistical validity standard selection 1234. The system and method can use all of these factors to execute the selection of a modeling technique.

Referring back to FIG. 13, a processor 1350 executes the functionality of each of the client interface 1355, the data analyzer 1340, and the data repository 1345. Each of the client interface 1355, including the client input interface 1330 and client output interface 1335, the data analyzer 1340, the data repository 1345, and the processor 1350 are in signal communication 1360 with each other. The system 1305 is connected to representative clients, shown as client 1315, client 1320, and client 1325, through network 1310. The network 1310 can be any of a variety of networks such as a network internal to an organization or external to an organization, or the cloud.

FIG. 9 is a flow diagram illustrating a process for project management in which the system may be applied. Referring to FIG. 9 and FIG. 13, the process begins by entering a project scenario acquisition stage 905 in which a client chooses a set of project characteristics for a proposed project to be estimated. The process continues with the client submitting the project characteristics to the system 1305 through the client input interface 1330, for use in reference class forecasting for project estimation. This occurs in a field determination stage 910 of the process in which the client first chooses project estimation constraint fields and project estimation response fields for purposes of setting input variables for reference class forecasting. The choices that the client makes for the project estimation response fields and project estimation constraint fields can be the defaults that a client views in the client interface 1355. The data analyzer 1340 receives metrics, provided by the client, for the project estimation constraint fields, and the process continues by entering an application stage 920. In the application stage 920, the data analyzer 1340 applies at least one reference class forecasting technique to determine the parameters of a logistic model based on project characteristics of the proposed project and project characteristics of historical reference projects included in a reference class of project data of a plurality of historical reference projects from the data repository 1345. The application stage 920 generates a resulting logistic model based metric, such as an FIPS or an FCPS for use in responding to the project scenario. The data analyzer 1340 then, in a response field metric determination stage 925, determines the appropriate form of response to the project scenario in accordance with requested project estimation response fields. The process then enters a response stage 930 in which the data analyzer 1340 provides the appropriate metrics for the project estimation response fields through the client output interface 1335. The process then enters a project execution stage 935 in which work is carried out on planned features of the proposed project. In a performance actuals stage 940, the data analyzer 1340 receives performance actuals for the progress of the proposed project to date. In the course of project execution, the process can use a monitoring stage 945 in which the data analyzer 1340 assesses the performance actuals for whether and what notifications or alarms should be triggered. Upon receipt of a notification or alarm by the client, the client can initiate a return to the project scenario stage 905 in connection for hypothetical scenario review 202. In the course of the project, the process can continually update historical project data in an update data stage 950, for inclusion in the data repository 1345.

In accordance with the invention, we disclose a feature planning granularity characteristic, and corresponding feature planning granularity metrics for use as a project characteristic in project planning and project estimation, including use in reference class forecasting as a project estimation constraint field metric or as a project estimation response field metric. The feature planning granularity metric is a value or set of values, such as an FIPS during the course of a project describing the cardinal number of identified features taken relative to the planned effort of the scope of a project. Stated another way, the metric represents the cardinality of identified features together with the user chosen scope or the scope as estimated by the system, such scope being expressed in terms of effort of the project. When selected as a project estimation response field, the metric of feature planning granularity is determined by reference class forecasting using the same historical projects and the same project estimation constraint metrics that are used as input variables for calculating the other project estimation response fields. When selected as a project estimation constraint field, the metric of feature planning granularity is used as an input variable for reference class forecasting determination of project estimation response field metrics. As will be discussed further in reference to FIGS. 4, 5, and 6 below, in each case, the metric of feature planning granularity provides guidance to users on the amount of feature planning breakout activity associated with other project estimation response field metrics and project estimation constraint field metrics used in project estimation and planning The metric of feature planning granularity can take any form that is useful, so long as the metric is based on the cardinality of identified features relative to the scope of the project, when scope is represented as the amount of effort of the project.

FIG. 8 is a schematic diagram illustrating metrics and components of the feature planning granularity characteristic and a corresponding feature completion progress schedule according to various embodiments. Box 805 is exemplary of cardinality of identified features. Box 820 shows identified features on a work breakout or work breakdown type of planning structure. The numbers within the planning structure are the amounts of planned effort contributed by each identified feature. In this example, features that are registered features are shown with an “R” designation. Box 825 is exemplary of a profile of cardinality of the identified features, showing the number of identified features having the indicated sizes of effort.

Box 810 of FIG. 8 contains information that is indicative of the project granularity characteristic and associated FIPS and scope of a project. In the example presented, Box 830 shows a feature planning granularity metric expressed as a percentage for a selected time x. Box 830 shows two percentage values, one representing actuals as the feature planning granularity exists at time x during the course of a project, the other showing an original estimated percentage for time x. The two percentages may be used in any project alarm or project status notification. Box 840 shows two FIPS curves. Curve 841 is an original estimated FIPS, and curve 842 shows the actuals for an FIPS, each as of time x. Box 835 shows a scope of the total project as planned as of time x, and a corresponding feature planning granularity metric indicative of an estimated average for the feature planning granularity of the total project. Box 815 shows corresponding FCPS curves as of time x. Curve 817 incorporates actuals of the FCPS for the project as performed up to time x. Curve 816 shows an extrapolation, which is an estimated FCPS for the project going forward, in accordance with the estimated feature planning granularity metrics presented in Box 810.

FIG. 4 is a diagram illustrating an interactive screen display 405 of the client interface depicting a project scenario according to various embodiments. A project estimation constraint field sector 410 shows exemplary project estimation constraint fields and corresponding metrics for those constraint fields, selected by a user in a proposed project scenario. Box 425 shows a project estimation constraint field of resources. Box 430 shows a project estimation constraint field of scope. Box 440 shows a project estimation constraint field of duration. A project estimation response field sector 415 shows exemplary project estimation response fields and corresponding metrics created in accordance with the system and method. Box 420 shows the average granularity of feature decomposition in an amount of XYZ, or feature planning granularity metric in the amount of XYZ, for example 25%, that was observed for a reference class of projects and the constraints listed in sector 410. Box 445 shows the success rate, or the percentage of projects within the reference class that reached a successful conclusion. Box 450 shows the forecasted FCPS showing the cumulative completion of registered features measured in units of FTEPDs. Box 455 is a tabular presentation of the information displayed in the graph in box 450, with an additional column of cumulative cost.

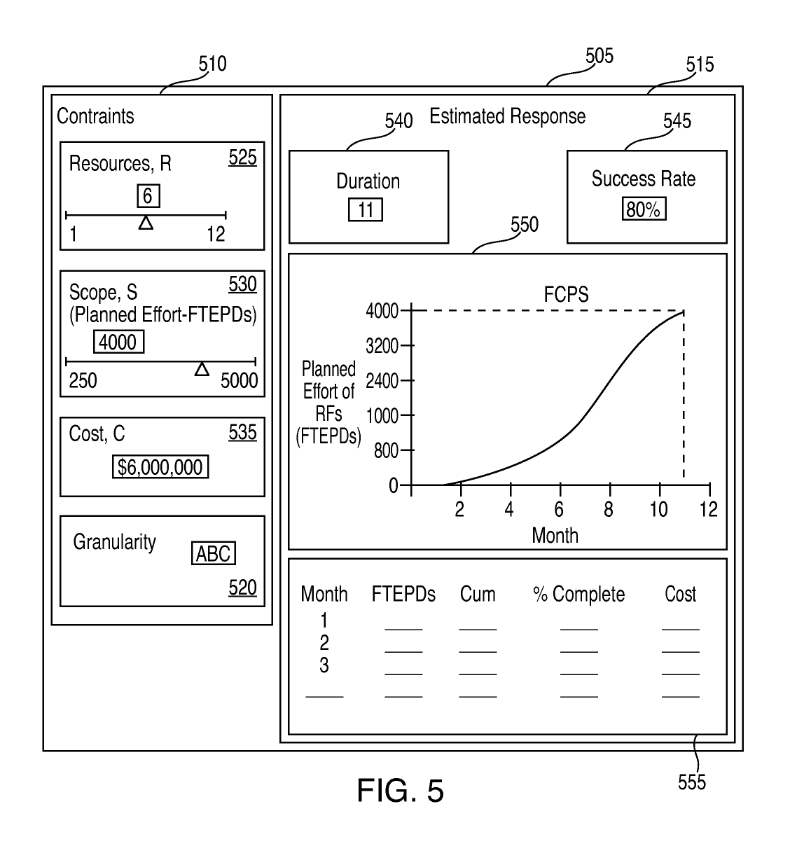

FIG. 5 is a diagram illustrating an interactive screen display 505 of the client interface depicting a project scenario according to various embodiments. A project estimation constraint field sector 510 shows exemplary project estimation constraint fields and corresponding metrics for those constraint fields, selected by a user in a proposed project scenario. Box 525 shows a project estimation constraint field of resources. Box 530 shows a project estimation constraint field of scope. Box 535 shows a project maximum cost field restriction. Box 520 shows a project estimation constraint field of feature planning granularity ABC, for example 25%. A project estimation response field sector 515 shows exemplary project estimation response fields and corresponding metrics created in accordance with the system and method. Box 540 shows the projected duration of 11 months based on a reference class of projects and the constraints listed in sector 510, including the feature planning granularity metric. Box 545 shows the success rate, or the percentage of projects within the reference class that reached a successful conclusion. Box 550 shows the forecasted FCPS showing the cumulative completion of registered features measured in units of FTEPDs. Box 555 is a tabular presentation of the information displayed in the graph in box 550, with an additional column of cumulative cost.

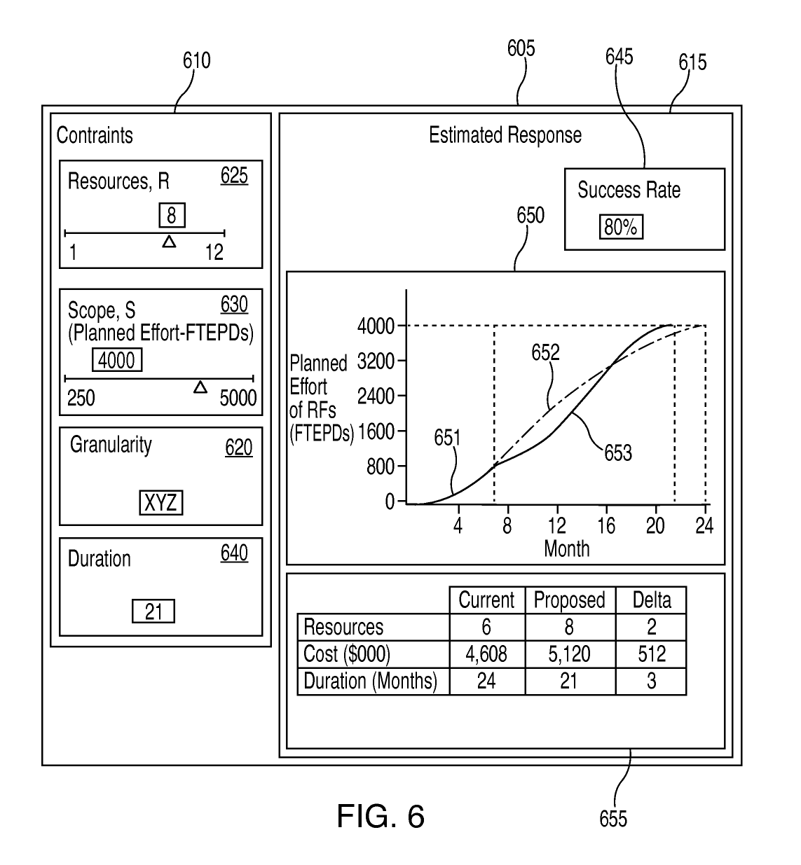

FIG. 6 is a diagram illustrating an interactive screen display 605 of the client interface depicting a mid-course project correction scenario according to various embodiments. A project estimation constraint field sector 610 shows exemplary project estimation constraint fields and corresponding metrics for those constraint fields, selected by a user in a proposed project mid-course correction scenario. Box 625 shows a project estimation constraint field of resources, where two additional resources are being added to the project for a total of 8. Box 630 shows a project estimation constraint field of scope, remaining constant. Box 620 shows a project estimation constraint field of feature planning granularity XYZ, for example 25%. Box 640 shows a project estimation constraint field of duration 21, in this case 3 months shorter than the original projected schedule that was based on six resources and 25% granularity. A project estimation response field sector 615 shows exemplary project extrapolation and reforecasting response fields and corresponding metrics created in accordance with the system and method. Box 645 shows the success rate, or the percentage of projects within a reference class that reached a successful conclusion. Box 650 shows the extrapolated and re-forecasted FCPS showing the cumulative completion of registered features measured in units of FTEPDs. The actual feature completion data is shown up through the current time as actual feature completion curve 651. The current forecast of project completion is shown by estimated feature completion curve 652, which extends to 24 months. The reforecasted feature completion curve 653 demonstrates that given the increase in resources from six to eight along with the other project estimation constraints of scope 4000, duration 21, and a user chosen granularity, the project is reforecasted to complete in only 21 months even though the feature completion rate is initially reduced as the newly added resources come up to speed. Box 655 is a summary presentation of the information displayed in the graph in box 650, showing the delta between the current values for resources, cost, and duration and the proposed resources, cost, and duration.

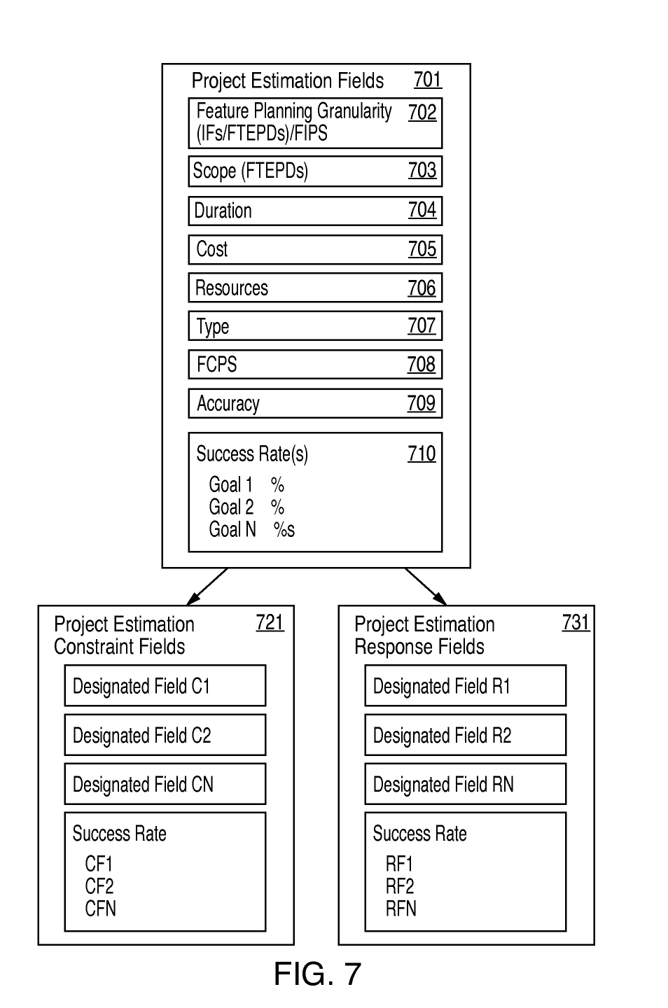

Referring to FIG. 7, project estimation fields for use in application stage 920, can include feature planning granularity 702, project scope 703, project duration 704, project cost 705, project resources 706, project type 707, project FCPS 708, predictive model accuracy 709, and project success rate 710. In a preferred embodiment of the invention, feature planning granularity 702 can be expressed as the number of identified features in relations, or as a ratio to FTEPDs. Success rate 710 can be measured based on defined goals, shown as goal 1, goal 2 or goal N. Success rates may be derived using data parsing or non-reference class analysis, with client selected criteria for what comprises success. Success can be a combination of meeting or approaching various constraints during the course of the project, as such constraints are chosen by the client in a user submission. As shown in FIG. 7, project estimation constraint fields 721 are selected from the project estimation fields 701. Remaining fields of the project estimation fields 701 may become project estimation response fields 731.

FIG. 10 is a schematic diagram illustrating reference class response determination according to various embodiments. Project estimation fields 1005 are considered by the client for selection as project estimation constraint fields and project estimation response fields. An inquiry submission 1010 through interface 1001 provides the client's selection for reference class forecasting data analytics 1002. Reference class forecasting 1015 operates on reference projects 1020 contained in the data repository 1003. Reference projects 1020 may be categorized for purposes of reference class forecasting 1015. Results for project estimation response fields based on the reference class forecasting 1015 are displayed via inquiry response 1025.

1. A computer implemented method of generating a feature planning granularity metric for use in project planning of a proposed project having characteristics represented by a plurality of project estimation fields having one or more project estimation constraint fields, the method comprising:
receiving via a computer processor a plurality of project estimation constraint metrics corresponding to respective project estimation constraint fields of the proposed project for use in generating a metric indicative of a feature planning granularity characteristic;
obtaining via the computer processor a reference class of project data of a plurality of historical reference projects, the data for each historical reference project comprising:
a metric representing cumulative identified features relative to a planned effort of the scope of the reference project for one or more points of time during the course of the reference project; and
a feature completion progress schedule for completed registered features and a corresponding amount of planned effort contributed by each respective registered feature to the planned effort of the scope of the reference project;
applying via the computer processor the project estimation constraint metrics in reference class forecasting on the reference class of project data, to generate a metric representing estimated cumulative identified features relative to a scope of the proposed project for one or more points of time during the course of the proposed project, wherein the estimated cumulative identified features have a cumulative effort larger than the effort of the scope of the proposed project; and
providing via the computer processor the metric representing estimated cumulative identified features relative to the effort of the scope of the proposed project, for use in project planning as the feature planning granularity characteristic.

2. The method of claim 1 wherein the effort of the scope of the proposed project and the planned effort of the scope of each historical reference project is measured in a baseline unit of full-time-equivalent-person-days.

3. The method of claim 1 wherein the project estimation constraint fields comprise at least one field of the group consisting of project scope, project duration, project cost, project resources, project success rate, and predictive model accuracy.

4. The method of claim 1 wherein the proposed project is a partially completed project.

5. The method of claim 1 wherein applying the project estimation constraint metrics in reference class forecasting comprises applying a logistic model to the reference class of project data to generate a feature identification progress schedule.

6. The method of claim 5 wherein applying the logistic model comprises using a regression technique to obtain parameter determination equations having as independent variables the project estimation constraint fields.

7. A computer implemented method of generating a feature completion progress schedule for use in project estimation of a proposed project having characteristics represented by a plurality of project estimation fields having one or more project estimation constraint fields, the method comprising:
receiving via a computer processor a plurality of project estimation constraint metrics comprising at least a metric indicative of a feature planning granularity characteristic expressed as a number of cumulative identified features relative to an effort of a scope of the proposed project;
obtaining via the computer processor a reference class of project data of a plurality of historical reference projects, the data for each historical reference project comprising:
a metric representing cumulative identified features relative to a planned effort of the scope of the reference project, wherein the cumulative identified features have a cumulative effort larger than the planned effort of the scope of the reference project; and
a feature completion progress schedule for completed registered features and a corresponding amount of planned effort contributed by each respective registered feature to the planned effort of the scope of the reference project;
applying via the computer processor the project estimation constraint metrics in reference class forecasting on the reference class of project data, to generate a feature completion progress schedule for the proposed project; and
providing via the computer processor the feature completion progress schedule for use in project estimation.

8. The method of claim 7 wherein the effort of the scope of the proposed project and the planned effort of the scope of each historical reference project is measured in a baseline unit of full-time-equivalent-person-days.

9. The method of claim 7 wherein the project estimation constraint fields further comprise at least one field of the group consisting of project scope, project duration, project cost, project resources, project success rate, and predictive model accuracy.

10. The method of claim 7 wherein the proposed project is a partially completed project having an original planned effort of scope, and wherein the metric indicative of the feature planning granularity characteristic is the number of cumulative identified features of the partially completed project relative to the original planned effort of scope.

11. The method of claim 7 wherein applying the project estimation constraint metrics in reference class forecasting comprises applying a logistic model using a regression technique to obtain parameter determination equations having as independent variables the project estimation constraint fields.

12. A computer implemented system for generating a feature planning granularity metric for use in project planning of a proposed project having characteristics represented by a plurality of project estimation fields having one or more project estimation constraint fields, the system comprising:
a client input interface operative to receive a plurality of project estimation constraint metrics corresponding to respective project estimation constraint fields of the proposed project for use in generating a metric indicative of a feature planning granularity characteristic;
a data repository operative to obtain a reference class of project data of a plurality of historical reference projects, the data for each historical reference project comprising:
a metric representing cumulative identified features relative to a planned effort of the scope of the reference project for one or more points of time during the course of the reference project; and
a feature completion progress schedule for completed registered features and a corresponding amount of planned effort contributed by each respective registered feature to the planned effort of the scope of the reference project;
a data analyzer in signal communication with the client input interface and the data repository, the data analyzer being operative to apply the project estimation constraint metrics in reference class forecasting on the reference class of project data, to generate a metric representing estimated cumulative identified features relative to a scope of the proposed project for one or more points of time during the course of the proposed project, wherein the estimated cumulative identified features have a cumulative effort larger than the effort of the scope of the proposed project; and
a client output interface in signal communication with the data analyzer and operative to provide the metric representing estimated cumulative identified features relative to the effort of the scope of the proposed project, for use in project planning as the feature planning granularity characteristic.

13. The system of claim 12 wherein the effort of the scope of the proposed project and the planned effort of the scope of each historical reference project is measured in a baseline unit of full-time-equivalent-person-days.

14. The system of claim 12 wherein the project estimation constraint fields comprise at least one field of the group consisting of project scope, project duration, project cost, project resources, project success rate, and predictive model accuracy.

15. The system of claim 12 wherein the proposed project is a partially completed project.

16. The system of claim 12 wherein applying the project estimation constraint metrics in reference class forecasting comprises applying a logistic model to the reference class of project data to generate a feature identification progress schedule.

17. The system of claim 16 wherein applying the logistic model comprises using a regression technique to obtain parameter determination equations having as independent variables the project estimation constraint fields.

18. A computer implemented system for generating a feature completion progress schedule for use in project estimation of a proposed project having characteristics represented by a plurality of project estimation fields having one or more project estimation constraint fields, the system comprising:
a client input interface operative to receive a plurality of project estimation constraint metrics comprising at least a metric indicative of a feature planning granularity characteristic expressed as a number of cumulative identified features relative to an effort of a scope of the proposed project;
a data repository operative to obtain a reference class of project data of a plurality of historical reference projects, the data for each historical reference project comprising:
a metric representing cumulative identified features relative to a planned effort of the scope of the reference project, wherein the cumulative identified features have a cumulative effort larger than the planned effort of the scope of the reference project; and
a feature completion progress schedule for completed registered features and a corresponding amount of planned effort contributed by each respective registered feature to the planned effort of the scope of the reference project;
a data analyzer in signal communication with the client input interface and the data repository, the data analyzer being operative to apply the project estimation constraint metrics in reference class forecasting on the reference class of project data, to generate a feature completion progress schedule for the proposed project; and
a client output interface in signal communication with the data analyzer and operative to provide the feature completion progress schedule for use in project estimation.

19. The system of claim 18 wherein the effort of the scope of the proposed project and the planned effort of the scope of each historical reference project is measured in a baseline unit of full-time-equivalent-person-days.

20. The system of claim 18 wherein the project estimation constraint fields further comprise at least one field of the group consisting of project scope, project duration, project cost, project resources, project success rate, and predictive model accuracy.

21. The system of claim 18 wherein the proposed project is a partially completed project having an original planned effort of scope, and wherein the metric indicative of the feature planning granularity characteristic is the number of cumulative identified features of the partially completed project relative to the original planned effort of scope.

22. The system of claim 18 wherein applying the project estimation constraint metrics in reference class forecasting comprises applying a logistic model using a regression technique to obtain parameter determination equations having as independent variables the project estimation constraint fields.
